(19) United States
(12) Patent Application Publication
(10) Pub. No.: US 2008/0193594 A1
(43) Pub. Date: Aug. 14, 2008

(54) Process for Seeding a Media with Microorganism in Form of a Tablet

(75) Inventors: Jean-Philippe Obert, Availles En Chatellerault (FR); Piotr Kolakowski, Olsztyn (PL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DANISCO A/S, Copenhagen (DK)

(21) Appl. No.: 11/547,841

(22) PCT Filed: Apr. 27, 2005
(86) PCT No.: PCT/IB2005/001458

§ 371 Date: Apr. 24, 2008

(30) Foreign Application Priority Data
Apr. 28, 2004 (FR) 0404508

(51) Int. Cl. A23C 9/12

(52) U.S. Cl. 426/43; 426/61

(57) ABSTRACT

The present invention provides a method of seeding a medium, said method comprising: contacting microorganisms with a medium, wherein said microorganisms are in the form of a tablet.

The present invention relates to tablets of microorganisms which can be used for direct or semi-direct seeding.

Microorganisms, in particular lactic bacteria, are used in numerous industries, in particular in the agri-food industry.

In particular, lactic bacteria are used inter alia in order to ferment, flavour, refine or texture food, in particular dairy products or cured products. They are also used to protect the media into which they are incorporated against contamination by other microorganisms and also used for their probiotic effects.

Depending on uses, lactic bacteria are marketed in the form of compositions comprising inter alia mixtures of lactic bacteria, which are called ferments or starters.

Ferments are generally in the form of concentrates, dry, lyophilized or frozen, or of a suspension and are most often used in suspension form. In the case of lactic bacteria in dry, lyophilized or frozen form, their use may necessitate a prior suspension.

These types of concentrated formulations have the double advantage of preserving the viability of the cultures over a long period of time and of being quite particularly suitable for direct seeding, where the ferment is directly introduced into the medium to be treated or seeded. Advantageously in this latter case, no preliminary culturing in a culture medium proves necessary before use of the ferment, unlike what is called semi-direct seeding.

When these ferments are used in dry or lyophilized form, they are in the form of a powder, which has certain drawbacks. In particular, a powder of microorganisms, because of its low density, is incapable of passing through the foam which may form when a liquid is transferred into an industrial tank, possibly for example the foam above a tank of milk.

In order to meet the requirements of industry, it has become necessary to find another means for direct seeding which avoids the drawbacks of powders.

Thus the problem which the invention proposes to resolve is that of providing a new means suitable for direct seeding.

Unexpectedly, the inventors have demonstrated that it is possible to use microorganisms in the form of tablets for direct or semi-direct seeding.

In a first aspect the present invention provides a method of seeding a medium, said method comprising: contacting microorganisms with a medium, characterized in that said microorganisms are in the form of a tablet.

In a second aspect the present invention provides a method of producing a fermented product, said method comprising: seeding a medium according to any one of the preceding claims, and fermenting said medium.

In a third aspect the present invention provides use of microorganisms for seeding a medium, wherein the microorganisms are in the form of a tablet.

The invention offers decisive advantages, in particular when the microorganisms are ferments; these advantages are the immediate availability of less bulky ferments, the stability of the microorganisms in the form of tablets at temperatures comprised between 0° C. and 40° C. depending on the type of microorganisms, the possibility of producing complex mixtures of species or different strains in determined and constant proportions, the increased regularity of the performances in comparison with standard ferments prepared where they are used, the strictly defined quality of the ferments.

Another advantage offered by the advantage is that the tablets of microorganisms can be used equally effectively for direct or semi-direct seeding.

Another advantage of the present invention is that the microorganisms in the form of tablets remain viable and are active when they are re-suspended. They can multiply anew in a medium propitious to their development, after having been compressed according to the invention.

Moreover, the microorganisms in the form of tablets have the advantage that no dust is generated when the tablet is handled, which means no loss of product.

Advantageously, the microorganisms in the form of tablets have a mechanical resistance allowing their handling.

The invention also has the advantage of being able to be put into practice in all industries, in particular the agri-food, pharmaceutical, cosmetic, food and farming industries, as well as in the fields of animal nutrition, animal feed, detergents, effluent treatment, pollution control and hygiene in the broad sense, in particular everyday hygiene, personal hygiene (for example toothpastes) or industrial hygiene.

In preferred aspects, the tablets according to the invention advantageously have a density higher than or equal to 0.8, preferably higher than or equal to 1. This advantage allows easier utilization in particular for seeding media found in industrial tanks.

Other advantages and characteristics of the invention will become clear on reading the following description and the examples which are given purely as illustrations and are non-limitative.

The invention relates to the use of microorganisms for seeding a medium characterized in that the microorganisms are in the form of tablets.

By the expression “in the form of tablets” is meant that a powder containing microorganisms has undergone compression or any other means of densification.

The tablets of microorganisms according to the invention can be obtained by compression, in a standard manner for a person skilled in the art, using any standard compression apparatus. It is possible to use a press, in particular a press having a cooling device. Among the types of press suitable according to the invention, the uniaxial Zwick® 1478 press can be mentioned. The compression pressure applied is at most 400 MPa, preferably at most 200 MPa. Preferably, the compression pressure applied is comprised between 20 MPa and 100 MPa, still more preferably comprised between 40 MPa and 80 MPa.

After compression, the tablets are preferably stored under a non-humid or only slightly humid atmosphere so as to prevent the microorganisms from becoming moist. Thus it is possible to store the tablets in for example a plastic bag, a container, a pillbox, an oxygen- and damp-proof aluminized pouch. Preferably, the tablets are kept at temperatures above 0° C., for example 4° C.

The microorganisms utilized according to the invention are preferably in the form of dry or lyophilized powder. They can contain different additives added during their drying or during their lyophilization. They can also contain activators of their biological activity, which are called activators, such as those described in patent application WO02/24870.

The microorganisms utilized according to the invention can be bacteria, for example lactic bacteria or probiotic bacteria, yeasts, fungi, moulds, algae, or spores of microorganisms.

Lactic bacteria likely to be suitable according to the invention include all the lactic bacteria customarily utilized in the agri-food, pharmaceutical, cosmetic, food and farming industries, as well as in the fields of animal nutrition, animal feed, detergents, effluent treatment, pollution control and hygiene in the broad sense, in particular everyday hygiene, personal hygiene (for example toothpastes) or industrial hygiene.

For guidance, the most-used lactic bacteria which are present in the ferments are those belonging to the genera Lactococcus, Streptococcus, Lactobacillus, Leuconostoc, Pediococcus, Bifidobacterium, Brevibacterium, Camobacterium, Enterococcus, Micrococcus, Vagococcus, Staphylococcus, Bacillus, Kocuria, Arthrobacter, Proprionibacterium and Corynebacterium. These lactic bacteria are used alone or in mixtures. This list is not exhaustive.

What are called probiotic bacteria can also be mentioned inter alia as suitable for the invention. By probiotic bacterium or strain is meant a strain which, ingested live, has a beneficial effect on the host, acting on the equilibrium of the intestinal flora. These probiotic strains have the ability to survive passage through the upper part of the digestive tube. They are non-pathogenic, non-toxic and have a beneficial effect on health, on the one hand via ecological interactions with the resident flora of the digestive tube and on the other hand via their ability to influence the immune tissue associated with the intestine in a positive manner. According to the definition of probiotics, these bacteria, when present in sufficient number, have the ability to pass through the whole intestine alive. They then form part of the resident flora during the period of administration. This colonization (or temporary colonization) allows the probiotic bacteria to have a beneficial effect, such as the repression of potentially pathogenic microorganisms present in the flora and interactions with the immune system of the intestine.

The microorganisms according to the invention can be mixed before being shaped into tablets with ingredients suitable for compression.

Among the ingredients suitable for compression, there can be mentioned:
soluble compressible compounds, in particular polysaccharides, oligosaccharides such as for example inulin, sugars such as for example sucrose, fructose or lactose, polyols such as for example sorbitol or mannitol, soluble salts such as for example carbonates or soluble phosphate salts including dibasic calcium phosphate;
insoluble compressible compounds, in particular microcrystalline cellulose, calcium silicates or insoluble phosphate salts such as for example tricalcium phosphate;
disintegrants, which facilitate the disintegration of the tablet when it is immersed in a liquid and allow the release of the microorganisms, in particular croscarmellose sodium, branched sodium carboxymethylcellulose, crospovidone, N-vinyl-2-pyrrolidone, starch or pregelatinized starch, carrageenans, guar gums, alginates.
lubricants, which facilitate the flow of the powders, the ejection of the tablet from the press after compression or which also make it possible to attenuate the anisotropy of the stresses within the pressed mass. By way of example, there will be mentioned stearic acid, magnesium, calcium, sodium or ammonium metallic stearates, silica, amino acids such as leucine, sodium benzoate, polyethylene glycols, or talc.

It is also possible to use commercially available pre-formulated compressible compounds.

Practice of the invention is possible by introducing the microorganisms in the form of tablets directly into the medium to be seeded (direct seeding) or by preparing a pre-culture to which the microorganisms in the form of tablets are added, before adding the pre-culture to the medium to be seeded.

The medium in which the microorganisms in the form of tablets can be used is preferably a food medium such as for example a dairy, meat, fruit-juice-based medium or an aqueous medium. It is preferably an aqueous medium.

By dairy medium is meant a medium comprising milk of animal and/or vegetable origin. As milk of animal origin there can be mentioned cow's, ewe's, goat's or buffalo's milk. As milk of vegetable origin there can be mentioned any fermentable substance of vegetable origin which can be used according to the invention in particular originating from soya seeds, rice or malt.

The medium to be seeded according to the invention can optionally be a liquid, gelated, gelatable or foamy medium.

The medium to be seeded according to the invention can optionally be a fermentable medium or a non-fermentable medium.

Generally, the microorganisms in the form of tablets can be used in the same manner as when they are in dry or lyophilizate form.

Among the uses/methods/processes according to the invention there can be mentioned the seeding of a tank of milk with microorganisms in the form of tablets, in order to produce for example a fermented milk, a yoghurt, a matured cream, a cheese, a fromage frais, a milk beverage, a milk product retentate, a processed cheese, a cream dessert, a cottage cheese or a milk for infants.

The present invention allows for seeding a medium continuous or discontinuous, automatable and aseptic in-line seeding.

By seeding according to the invention is meant adding microorganisms to a medium. The term inoculation of a medium is also used. This medium is preferably an industrial medium, i.e. produced by an industry.

The present invention can comprise a stage of incubation of the medium seeded with microorganisms in the form of tablets, under conditions favourable to the metabolic activity of the microorganisms. This stage can make it possible to obtain, depending on the case, a medium rich in microorganisms or a fermented product depending on the type of microorganisms used.

The present invention can be implemented in the agri-food, pharmaceutical, cosmetic, food and farming industries, as well as in the fields of animal nutrition, animal feed, detergents, effluent treatment, pollution control and hygiene in the broad sense, in particular everyday hygiene, personal hygiene (for example toothpastes) or industrial hygiene.

The present invention may be utilised in the seeding of a medium with microorganisms in the form of tablets to produce a fermented product. Preferably the fermented product is a home fermented product. Microorganisms in the form of a tablet are particularly useful in the production of a home fermented product. Such a tablet negates the need for the consumer to carefully measure out and/or resuspend the microorganisms to be used whilst ensuring consistency with regard to the amount and combination of microorganisms used in batches. Furthermore, such a tablet is easier to handle and store at home.

Preferably the present invention may be utilised in the seeding of a medium with microorganisms in the form of tablets to produce a fermented milk product. Examples of fermented milks are, but are not limited to, Kefir, Koumiss, Dahi, Skyr, Irgo, Itito, Mala and Acidophilus milk.

The present invention may be utilised in the seeding of milk with microorganisms in the form of tablets to produce Kefir. Kefir is producable by incubating heat-treated milk with microorganisms in the form of a tablet for approximately 24 hours at 20° C. or by incubating for 20 hours at 21-22° C. In one embodiment, the microorganisms comprise 80% lactococci, 5% lactobacilli and 5% yeast. In another embodiment, the microorganisms comprise up to 80% lactococci, up to 10% lactobacilli and up to 1% yeast. Preferably the microorganisms comprise 99% lactic acid bacteria and 1% yeast. More preferably, the microorganisms comprise 99% lactic acid bacteria and 0.02% yeast.

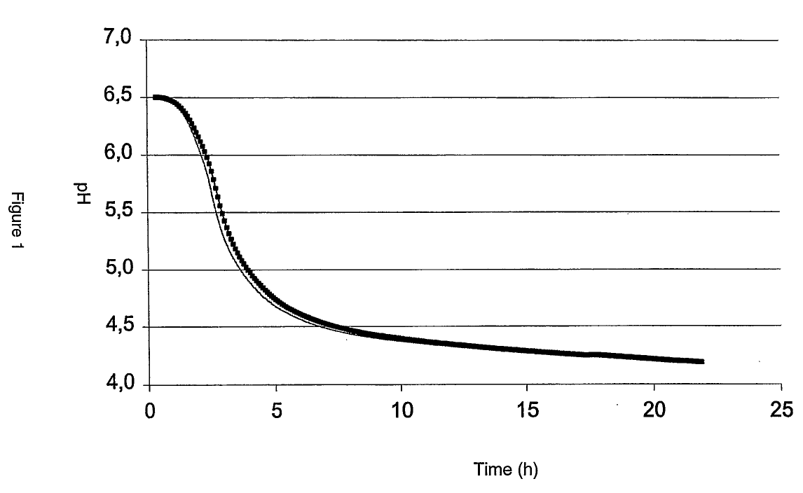

FIG. 1 shows the comparative acidification results obtained for bacteria in the form of tablets and for the same lyophilized bacteria.

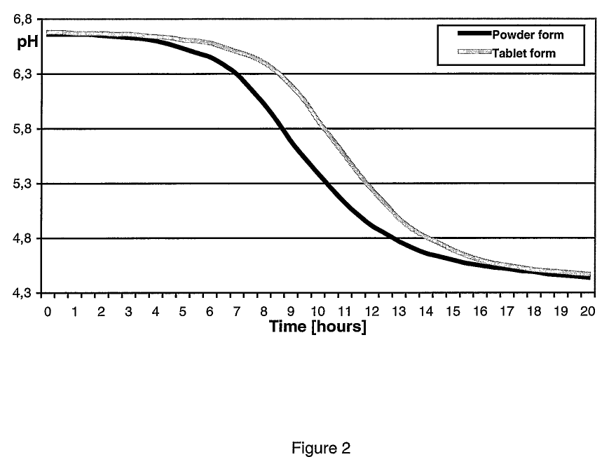

FIG. 2 shows the comparative acidification results for the kefir culture and the tablet (produced according to the method described) after inoculation of UHT milk incubated at 24° C.

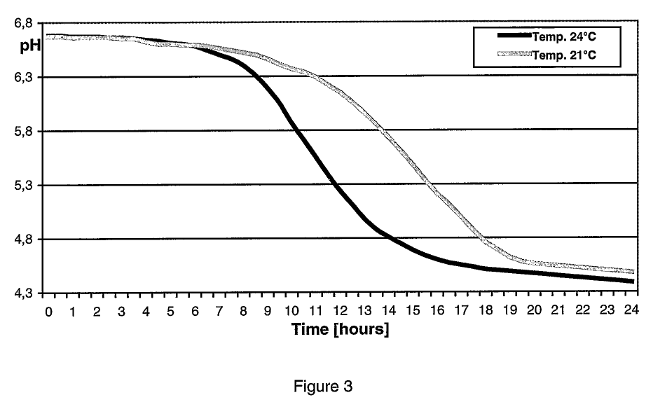

FIG. 3 shows comparative acidification results at different temperatures

The following examples illustrate the invention without limiting its scope.

### EXAMPLE 1

1-1 Production of lactic bacteria tablets:

Before the compression stage, the lactic bacteria are mixed with the compression additives using, for example, a Turbula® planetary-type mixer.

The compression additives used are the following:

0.5% stearic acid

2% croscarmellose sodium

48.75% microcrystalline cellulose

48.75% lyophilized lactic bacteria (EZAL MYE 95 ferment).

The percentages are by mass relative to the total mass of powder.

This mixture is then directly compressed using a Zwick® 1478 uniaxial press (Compression pressure: 60 MPa, tablet mass 1 g, tablet diameter: 1.3 cm).

A non-powdery tablet able to be handled is then obtained (hardness of approximately 7 kP) which will disintegrate very rapidly upon contact with an aqueous medium, in less than 5 minutes. Moreover, the ferment in tablet form retains its functionalities (acidification, texture, flavouring etc.).

By “very rapid disintegration” is meant that the tablet disintegrates completely (visual absence of aggregates) over a period of less than 5 minutes, under the conditions of a standardized test. This standardized test consists of displaying the disintegration of the tablet when the latter is placed in water at ambient temperature (use of a 2-litre beaker filled with 1.8 litres of water, at a temperature comprised between 18° C. and 25° C.) under gentle stirring (use of a stirring grid measuring 55×40 mm placed 3 cm from the bottom of the beaker, and the rotational speed of which is 120 rpm).

1-2 Production of a fermented medium:

According to the invention, the medium to be fermented is inoculated with the tablet, produced in 1-1, using the seeding dose recommended for these lactic bacteria. For example, for a milk matrix, the recommended usage dose for the ferment MYE 95 is 4 units (U) for 100 litres of milk.

FIG. 1 below shows the comparative acidification results obtained for the lyophilizate (dotted line) and the tablet (produced according to the method described previously—solid line) after inoculation at 4 U/100 litres of a UHT milk medium incubated at 43° C.

As the curves showing the acidification of the lyophilizate and the tablet are virtually superimposed, it can therefore be concluded that compression does not alter the functionalities of the lactic bacteria.

### EXAMPLE 2

2-1 Production of tablets for home made kefir—“Tybet kefir”

Composition of kefir culture:

kefir grains

BT001 (Lactic acid bacteria—mesophilic bacteria—Lactococcus)

Lactobacillus acidophilus NCFM

All components are in freeze-dried form.

Before the compression stage, kefir culture is mixed with the compression additives using, for example, a Turbula® planetary-type mixer.

The compression additives used are the following:

1% magnesium stearate

2% croscarmellose sodium

4% sodium glycollate

53% microcrystalline cellulose

40% freeze-dried kefir culture (Tybet kefir).

The percentages are by mass relative to the total mass of powder.

This mixture is then directly compressed using a Tablet Press Machine Greatide (Taivan) with a capacity of 450 tablets per minute (compression pressure: 60 MPa, tablet mass: 0.5 g, tablet diameter: 0.8 cm).

A non-powder tablet is then obtained (hardness of tablet: 5.5 kP) which disintegrates very rapidly upon contact with an aqueous medium, in less then 4 minutes, and is completely dissolved in less than 9 minutes. Moreover, the culture in tablet form retains its functionalities (acidification, texture, flavouring etc.).

By “completely dissolving” it is meant that the tablet disintegrates completely (visual absence of aggregates) under the conditions of a standardized test. This standardized test consists of displaying of tablet dissolving when the tablet is placed in water at ambient temperature (use of a 250 ml of water, at a temperature between 22° C. and 24° C.) under stirring at 750-800 rpm.

Microbial composition of kefir culture before and after compression (tablet) is shown in table 1. FIG. 2 shows the comparative acidification results for the kefir culture and the tablet (produced according to the method described) after inoculation of UHT milk incubated at 24° C.

2-2 Production of kefir “Tybet kefir” at home

According to the invention, the milk to be fermented is inoculated with the tablet. Recommended usage dose for the kefir culture is one tablet (0.5 g) for one litre of milk. Any milk, starting from non-fat to whole milk may be applied. For example, cow, goat, sheep and soya milk may be used for kefir production. UHT or pasteurized trade available milk is recommended. However, for raw milk it should be heated up to around 80° C. and immediately cooled down in tap water to room temperature before the tablet is added. The recommended incubation temperature is room temperature—the best range is 20-25° C.

Depending on temperature, the fermentation time fluctuates from 16 to 24 hours. The higher the temperature, the shorter the fermentation time needed.

FIG. 3 below shows comparative acidification results for different temperatures. End of fermentation can be recognized by visible curd and some whey release.

Prolonged fermentation has no negative impact (up to 24 h) due to the fact that the post-acidification effect is very limited (FIG. 2).

The kefir is refrigerated to stop the fermentation process.

Preparation:

Add one tablet directly to an opened 1-liter carton of room-temperature UHT milk, 2% of fat, close it, shake twice for a few seconds (the second shaking after 15 minutes of incubation).

Leave it at room temperature (24° C.). The time of fermentation to reach pH 4.55-4.6 is about 16 hours.

Refrigerate the kefir to stop the fermentation process.

Microbial kefir composition one day after production is listed in Table 2.

TABLE 1
Microbial composition of kefir culture before and after compression

| | Total | | |
|---|---|---|---|
| | mesophilic | | |
| | lactic acid | Lactobacillus | |
| | bacteria | acidophilus | Yeast |
| Sample | cfu/g | | |
| Kefir culture (powder | 5.4E+10 | 1.0E+08 | 8.0E+04 |
| form) | | | |
| Kefir culture (tablet form) | 2.0E+10 | 1.3E+07 | 4.2E+04 |

TABLE 2
Microbial kefir composition one day after production

| | | | | | Leuconostoc |
|---|---|---|---|---|---|
| | Total lactic | | | | or/and mesophilic |
| | acid | Total aroma | Lactobacillus | | heterofermentative |
| | bacteria | forming | acidophilus | Yeast | Lactobacillus |
| Sample | cfu/ml | | | | |
| Kefir culture | 3.0E+09 | 1.8E+09 | 1.6E+07 | 1.2E+02 | 3.0E+06 |
| (powder form) | | | | | |
| Kefir culture | 2.2E+09 | 1.2E+09 | 1.4E+07 | 7.0E+01 | 2.5E+06 |
| (tablet form) | | | | | |

FIG. 2. shows milk acidification curves (UHT, 2% of fat) by kefir culture type before compression (powder form) and after compression (tablet form) at temperature 24° C.

FIG. 3 shows milk acidification curves (UHT, 2% of fat) by kefir culture in tablet form at different temperatures.

Some embodiments of the present invention will now be illustrated by way of numbered paragraphs:

1. Use of microorganisms for seeding a medium characterized in that the microorganisms are in the form of tablets.

2. Use according to paragraph 1 characterized in that the microorganisms have been subjected to a compression pressure of at most 400 MPa, preferably at most 200 MPa.

3. Use according to one of the preceding paragraphs characterized in that the medium to be seeded is a liquid, gelated, gelatable, foamy, fermentable or non-fermentable medium.

4. Use according to one of the preceding paragraphs characterized in that the medium to be seeded is a food medium such as for example a dairy, milk, fruit-juice-based or aqueous medium.

5. Use according to one of the preceding paragraphs characterized in that the microorganisms are bacteria, for example lactic bacteria or probiotic bacteria, yeasts, fungi, moulds, algae, or spores of microorganisms.

6. Use according to one of the preceding paragraphs characterized in that it is implemented in the agri-food, pharmaceutical, cosmetic, food and farming industries, as well as in the fields of animal nutrition, animal feed, detergents, effluent treatment, pollution control and hygiene in the broad sense, in particular everyday hygiene, personal hygiene (for example toothpastes) or industrial hygiene.

7. Use according to any one of the preceding paragraphs characterized in that the micro-organisms are lyophilised.

8. Use according to any one of the preceding paragraphs characterized in that the seeding is direct seeding.

All publications mentioned in the present specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A method of seeding a medium, said method comprising:
contacting microorganisms with a medium
wherein said microorganisms are in the form of a tablet.

2. A method according to claim 1, characterized in that said medium is a food medium.

3. A method according to claim 1 or claim 2, characterized in that said food medium is a dairy, milk, fruit-juice-based or aqueous medium.

4. A method according to any one of the preceding claims, characterized in that the microorganisms have been subjected to a compression pressure of at most 400 Mpa.

5. A method according any of the preceding claims characterized in that the microorganisms have been subjected to a compression pressure of at most 200 Mpa.

6. A method according to one of the preceding claims characterized in that the medium to be seeded is a liquid, gelated, gelatable, foamy, fermentable or non-fermentable medium.

7. A method according to one of the preceding claims characterized in that the microorganisms are bacteria, yeast, fungi, moulds, algae, or spores of microorganisms.

8. A method according to claim 7 characterized in that said bacteria are lactic bacteria and/or probiotic bacteria.

9. A method according to one of the preceding claims characterized in that it is implemented in the agri-food, pharmaceutical, cosmetic, food and farming industries, as well as in the fields of animal nutrition, animal feed, detergents, effluent treatment, pollution control and hygiene in the broad sense, in particular everyday hygiene, personal hygiene (for example toothpastes) or industrial hygiene.

10. A method according to any one of the preceding claims characterized in that the microorganisms are lyophilised.

11. A method according to any one of the preceding claims characterized in that the seeding is direct seeding.

12. A method of producing a fermented product, said method comprising:
seeding a medium in accordance with a process defined in any one of the preceding claims
and fermenting said medium.

13. A method according to claim 12 characterised in that said fermented product is a fermented milk product.

14. A method according to claim 12 or claim 13 characterized in that said fermented product is a home fermented product.

15. Use of microorganisms for seeding a medium, wherein the microorganisms are in the form of a tablet.

16. Use according to claim 15, for the preparation of a fermented product.

17. Use according to claim 16 characterized in that said fermented product is a fermented milk product.

18. Use according to claim 17 characterized in that said fermented milk product is Kefir, Koumiss, Dahi, Skyr, Irgo, Itito, Mala or Acidophilus milk.

19. Use according to claim 18 characterized in that said fermented milk product is Kefir.

20. Use according to any one of claims 16 to 19 characterized in that said fermented product is home fermented.

21. A method as substantially hereinbefore described with reference to the Examples.

22. A use as substantially hereinbefore described with reference to the Examples.
